(19) United States
(12) Patent Application Publication
(10) Pub. No.: US 2006/0080151 A1
(43) Pub. Date: Apr. 13, 2006

(54) Healthcare management method and system

(75) Inventor: Andrew Barbash, Bethesda, MD (US)

Correspondence Address: Mintz, Levin, Cohn, Ferris, Glovsky & Popeo, PC, Chrysler Building, 666 Third Avenue, New York, NY, 10017, US

(73) Assignee: LAXOR, LLC

(21) Appl. No.: 11/248,876

(22) Filed: Oct. 11, 2005

Related U.S. Application Data
(60) Provisional application No. 60/616,992, filed on Oct. 8, 2004.

(51) Int. Cl. G06F 19/00

(52) U.S. Cl. 705/3

(57) ABSTRACT

The present invention is a system and a method for managing health records of a patient on a secure healthcare information network. It includes registering the patient with the healthcare information network; establishing a healthcare account for the patient; gathering personal and medical information about the patient; wherein the gathering step further comprises: requesting at least one healthcare provider of the patient to register with the healthcare information network and receiving information about the health of the patient from at least one healthcare provider of the patient, the patient, at least one custodian of the patient, or any authorized entity associated with the patient; compiling a health record summary of the healthcare account of the patient based on the received information; requesting additional healthcare providers for the patient to register with the healthcare information network and supply information about the health of the patient; and updating the health record summary.

### CROSS-REFERENCE TO RELATED APPLICATIONS

This Application claims priority to U.S. Provisional Patent Application No. 60/616,992 to Barbash, filed Oct. 8, 2004, and entitled “Healthcare Management Method and System” and its subject matter is incorporated herein by reference in its entirety.

### BACKGROUND OF THE INVENTION

1. Field of Invention

The present invention relates to a field of maintaining individual healthcare records. Specifically, the invention is a system and method that allows for secure and accurate maintenance and update of individual's healthcare records.

2. Background of the Invention

It is not uncommon for individuals to have a medical record. Typically, medical records contain personal and medical information. The personal information can include individual's name, address, telephone, gender, date of birth, etc. Medical information can include individual's medical history of illnesses, surgeries, allergies, necessary medications, and other vital information about individual's health. Medical information gets constantly updated as the individual ages, becomes ill, visits a healthcare provider, has a surgery, etc. Every time an individual visits a different healthcare provider (i.e., a doctor, a hospital, a clinic, a pharmacy, etc.), the healthcare provider creates a medical record for the individual. For each visit to a new healthcare provider, a medical record has to be created for the individual to ascertain his or her medical conditions and other medical history. The provider has to know this information in order to prescribe an appropriate treatment plan or course of action. For the individual to re-tell the medical history every time he or she visits a healthcare provider is not only inconvenient, but also present various accuracy issues, which can lead to serious problems down the road. For example, a patient may forget that he or she is allergic to certain kinds of medications and a healthcare provider prescribes such medication for the individual that causes serious medical problems for the individual. A study of the Institute of Medicine estimates that as many as 98,000 people die each year as a result of preventable medical errors. One of the single largest components of these errors is a medication error. A complete medical record can significantly reduce the likelihood of this error.

Currently, none of the millions of medical records that are held by healthcare providers' offices are connected with each other. Thus, most individuals rely on their healthcare providers to maintain their medical record in an accurate and up-to-date fashion, despite the fact that the individual may visit a number of different doctors for different issues. Rarely is one doctor the source of referrals or the depository of this information. Often, no single medical provider has a complete medial record and only the individuals themselves are capable of knowing where all of the relevant information can be found. A simple example is the increasing number of dietary supplements, which only the individuals would know and that most medical offices do not even ask about. Again, only the individuals are likely to be able to assemble all of this information, but not without help.

Assembling a record under the care and supervision of the individual is an important task, especially if healthcare providers are to make use of the record. Currently, there are software packages that allow individuals to assemble such records. However, because proper instruction and supervision is not available, most individuals cannot do this simply through the use of software alone. For example, test results must be part of the record, if it is to be accurate. Rarely do individuals have such test results themselves but must rely on their doctors to provide them. Getting such information is not an easy task, even with the authority of HIPAA regulations. There must be a knowledgeable intermediary familiar with the language and the technology and able, on behalf of the individual, to assist in this undertaking.

Ultimately, the record is the responsibility of the patient or their spouse/guardian, etc. Healthcare providers who share in the record must take responsibility for what they add in the record. Patients also need help in completing, maintaining, optimizing, and managing their health record.

Further, an individual's medical records from various healthcare providers are not available on an immediate basis. For example, an emergency happened and an individual is unconscious. In this situation, an immediate access to the individual health record is vital in providing proper care or in extreme situations in saving his or her life. Thus, there is a need for a system that would allow an immediate access to an individual's complete medial record, which is compiled and updated by the individual and his or her healthcare providers.

### BRIEF SUMMARY OF THE INVENTION

The present invention relates to a system and a method for maintaining health records of an individual on a healthcare information network. The system and method perform the following steps to maintain individual's health records: register the individual with the healthcare information network and establish a healthcare account for the individual. The healthcare includes medical and personal information about the individual. Then, the system and method gather personal and medical information about the individual, where medical information relates to the health of the individual.

To gather information about the individual, the following steps are performed: request at least one healthcare provider of the individual to register with the healthcare information network and then receive information about the health of the individual from at least one entity selected from a group consisting of at least one healthcare provider of the individual, the individual, at least one custodian of the individual, and any entity relating to the individual. Such receipt of the information can be obtained through a secure line of communication to prevent unauthorized access to the individual's record.

Then, the system and method compiles a health record summary of the healthcare account of the individual. The health record summary is based on the personal and medical information received from the individual and the healthcare provider of the individual. Additional healthcare providers for the individual are requested to register with the healthcare information network and supply information about the health of the individual. The health record summary is then updated with all the information. In subsequent visits to various medical providers, a visit summary is requested that is then posted to the record. Visit summaries that can be provided at the time of the visit are an increasing part of any office based electronic medical record.

In an alternate embodiment, the individual is allowed to personalize the healthcare account by designating groups of healthcare providers according to health needs of the individual. The individual is allowed to interact with the healthcare providers of the individual regarding the health needs of the individual.

In another alternate embodiment, the information about the individual is changed in the healthcare account of the individual. Upon change of the information, at least one healthcare provider of the individual is notified about the change.

The healthcare provider can be a physician of the individual, a hospital, a medical clinic, a medical specialist, allied health professional (e.g., physical therapist) or a dental professional. The individual can be a person, a family or a group of persons.

In an embodiment, the individual updates his or her own health record summary. In an alternate embodiment, at least one healthcare provider for the individual updates the health record summary of the individual.

The medical information about the individual includes medications taken by the individual, medical conditions of the individual, allergies of the individual, and treatment options tailored to the individual. The personal information includes a first name of the individual, a last name of the individual, a date of birth of the individual, an address of the individual, and an emergency contact for the individual. The medical and personal information can be available through a web site on a World Wide Web, a smartcard, a driver license, a medical insurance card, an electronic device, such as a cell phone, PDA, laptop, or any other means.

Further features and advantages of the invention, as well as structure and operation of various embodiments of the invention, are disclosed in detail below with references to the accompanying drawings.

### BRIEF DESCRIPTION OF THE FIGURES

The present invention is described with reference to the accompanying drawings. In the drawings, like reference numbers indicate identical or functionally similar elements. Additionally, the left-most digit(s) of a reference number identifies the drawing in which the reference number first appears.

FIG. 1 illustrates an exemplary embodiment of a communication system between a plurality of patients, healthcare providers and personal health information system.

FIG. 2 is a flowchart illustrating an exemplary embodiment of a method for managing health records of an individual on a healthcare information network, according to the present invention.

FIG. 3 is a flowchart illustrating an alternate embodiment of the method shown in FIG. 2.

FIG. 4 is a flowchart illustrating an alternate embodiment of the method shown in FIG. 2.

FIG. 5 is a flowchart illustrating an exemplary embodiment of using personal health information manager (“PHIM”) to invite healthcare providers to join the PHIM system in order to provide information about a patient, according to the present invention.

FIG. 6 is a flowchart illustrating an exemplary embodiment of registering and authenticating a healthcare provider with the PHIM system, according to the present invention.

FIG. 7 is a flowchart illustrating an exemplary embodiment of performing group invitations using the PHIM system, according to the present invention.

FIG. 8 is a flowchart illustrating an exemplary embodiment of receiving family group administrator authentication rights, according to the present invention.

FIG. 9 illustrates an exemplary embodiment of the PHIM system shown in FIG. 1, according to the present invention.

### DETAILED DESCRIPTION OF THE INVENTION

The present invention relates to managing of heath records of individuals. Specifically, the present invention relates to a secure web-based health record system and method. The present invention allows for the collaborative sharing of clinical information across multiple practices in multiple geographic locations in a secure manner, no matter what information system and no matter if records are electronic or paper-based. Having all the information a healthcare provider needs when treating a patient, regardless of where the information originated, will enhance productivity and the quality of care. The patient can be an individual, a group of individuals, or a family.

The present invention is adaptable to the current medical record systems, so that for health professionals, embodiments of the present invention do not demand changes in current workflow, nor do they involve any major capital expenditure if access to the Internet is already in place. The present invention is designed for front-end simplicity, while having back-end transparent complex data management.

For the health care consumer, embodiments of the present invention provide the ability to interact with their health information in a manner that is both structured and easy to utilize. This is because of the simple intuitive nature of the invention itself.

Nonetheless, given the intellectual, cultural and generational diversity of those receiving and providing health care services it is clear that the availability of a human interface is necessary. The concept of electronic medical records and similar products has been available. However, until such tools are paired with educational user support to match the user's comfort level with, and availability of, technology, the use and integration of online health information tools, especially by consumers, will most likely continue to be sluggish at best.

The Personal Health Information Manager (PHIM) is a feature of the present invention that provides such support to users. The mission of the PHIM is to support health professionals and health care consumers in managing personal health information utilizing, for example, the systems and methods of the present invention.

In an embodiment, PHIM may use secure web-based services to support establishing a secure online relationship management process between patients and providers. Specific tasks may be performed for each of these entities as outlined below.

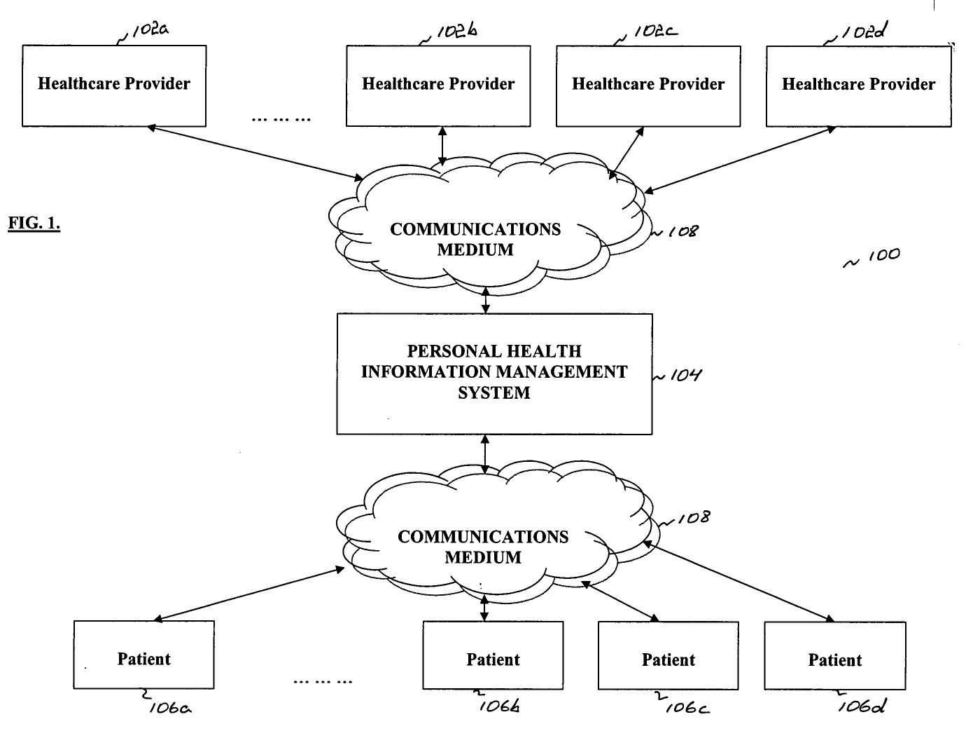

FIG. 1 illustrates an exemplary embodiment of a system 100 for managing healthcare records. The system 100 includes a personal health information management (“PHIM”) system 104 connected to a plurality of healthcare providers 102 (a, b, c, d) and to a plurality of patients 106 (a, b, c, d) via a communications medium 108.

The PHIM system 104 allows patients 106 and healthcare providers 102 to interact with each other for compiling of a particular patient 106 medical records. To compile a medical record, the patient 106 registers with the PHIM system 104. The patient 106 then submits information about herself/himself to the PHIM system 104 via communications medium 108. The patient information can include personal and medical information. The personal information includes patient's name, address, contact telephone numbers, gender, weight, height, and other non-medical information. The medical information includes patient's medical history of illnesses, any surgeries that the patient had, allergies, required medications, healthcare provider recommendations for treatments, and other medical information. Further, the patient can be a single individual, a family of individuals, or a group of individuals. The communications medium 108 can be an Internet, Intranet, or any other communications network that allows communications between patients 106, the PHIM system 104, and the healthcare providers 102. The healthcare providers can be physicians, specialists, nurses, surgeons, dentists, hospitals, medical clinics, pharmacies, and other persons and facilities capable of providing medical assistance to the patient 106. As can be understood by one having ordinary skill in the relevant art, the definitions of patients 106, healthcare providers 108, and communications medium 108 are not limited to those stated above.

In an embodiment, the patient 106 submits information to the PHIM system 104 via a secure connection, such as a 128 bit connection. This ensures that the patient submitted information is not subject to an unauthorized access. In that respect, the patient 106 can select healthcare providers 102 and other individuals who will have access to his or her health record stored with PHIM system 104. To do so, the patient 106 can “invite” specific healthcare providers 102 to join PHIM system 104. This means that the patient 106 requests that the PHIM system 104 sends an invitation to patient-selected healthcare providers 102 in order to submit information for the patient 106 medical record stored at PHIM system 104.

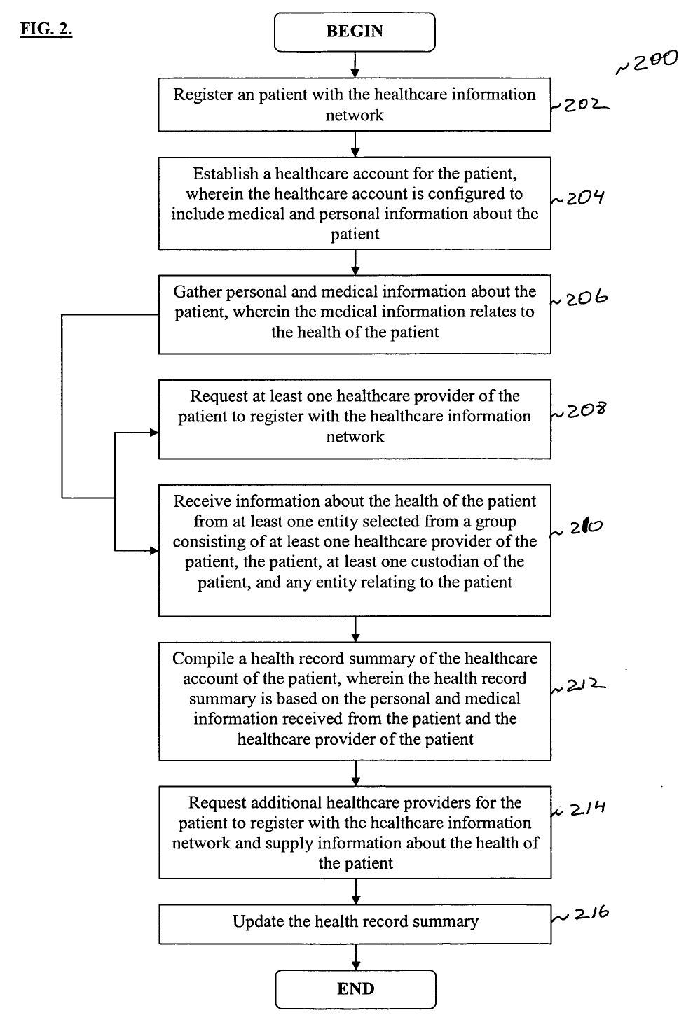

The PHIM system 104 can include a plurality of central processing units 902, memory units 904, display units 906 and Internet communication portals 908. Further, the PHIM system 104 includes PHIM system software 910 configured to perform functions described below with respect to FIGS. 2-8.

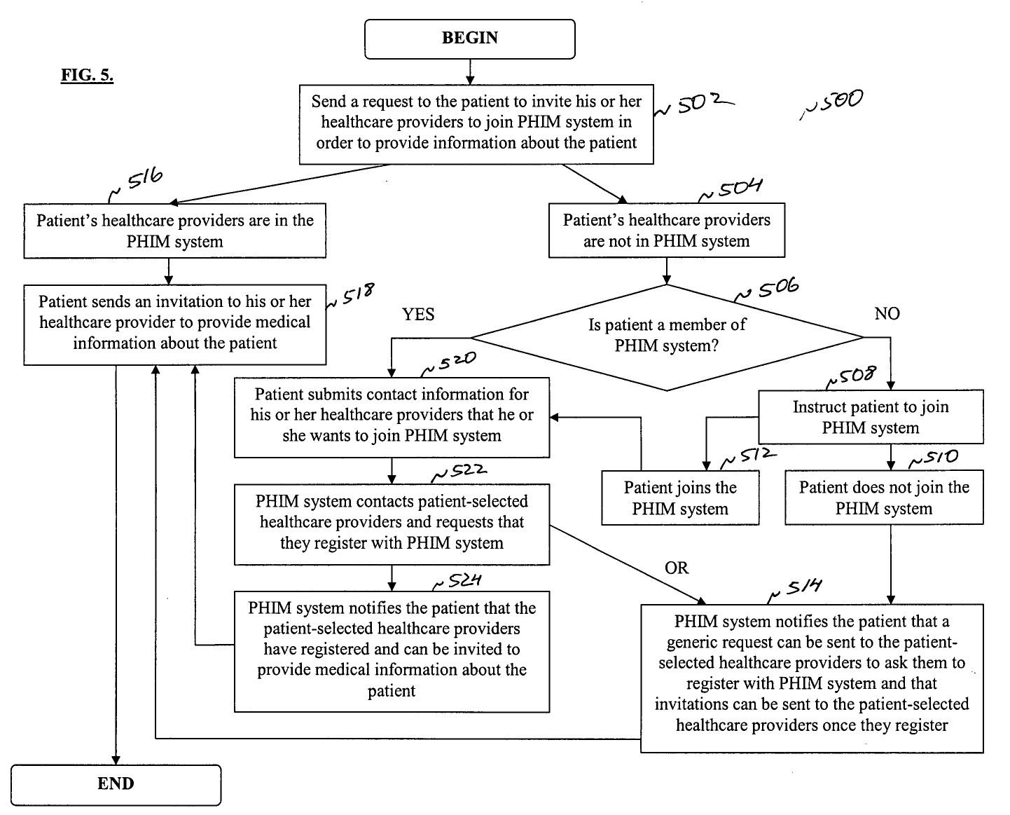

An invitation process 500 is described in FIG. 5. In step 502, PHIM system 104 sends contacts the patient 106 and requests that the patient “invite” his or her healthcare providers to join PHIM system 104 in order to provider information about the patient. As part of the invitation process, the healthcare providers would register with the PHIM system 104 for the purposes of providing medical information about a patient. Only the registered healthcare providers will be able to provide medical information about the patient. This way, the PHIM system 104 maintains integrity of the patient's medical record.

Depending on whether the patient-selected healthcare providers 102 are already registered with the PHIM system 104, the processing proceeds to either step 504 or step 516. If the patient-selected healthcare providers 102 are already registered with the PHIM system 104, then processing proceeds to step 516. The PHIM system 104 can employ separate algorithm to determine if the patient-selected healthcare providers 102 are registered with the PHIM system 104.

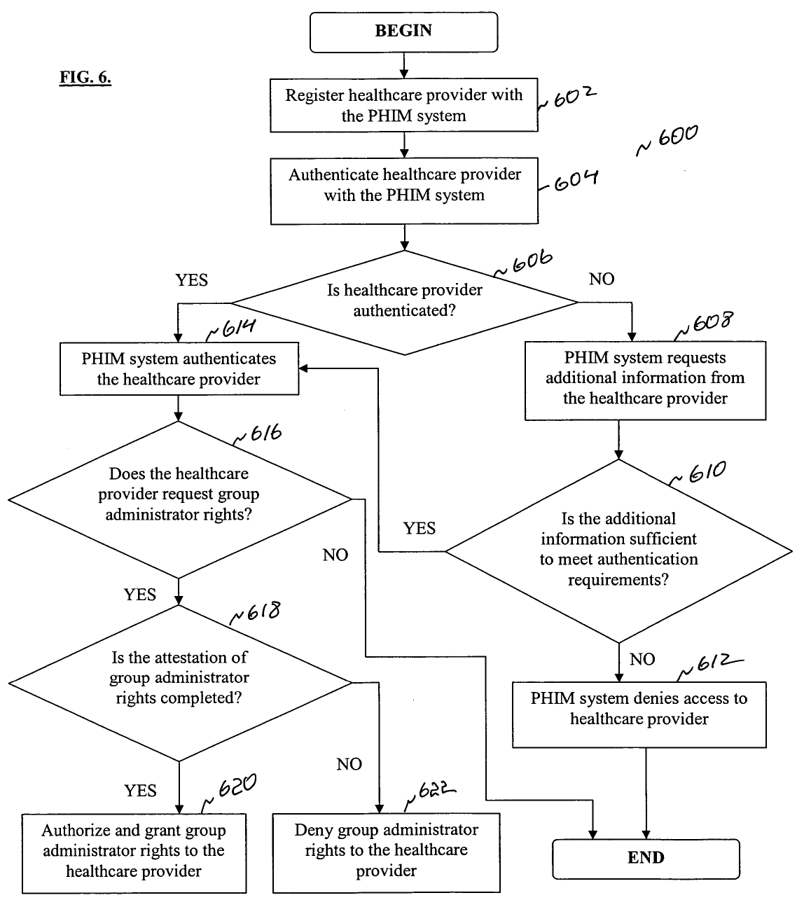

If the patient-selected healthcare providers 102 are registered with the PHIM system 104, the processing proceeds to step 518. In step 518, the patient sends an invitation to the selected healthcare providers 106 to provide medical information about the patient. Once the patient-selected healthcare provider joined the PHIM system 104, it can provide the requested medical information about the patient. As stated above, this information includes new and old medical history information, updated allergies information, treatment plans (including surgeries), specific conditions, new medications, and other information. A process by which the patient-selected healthcare provider 102 can submit medical information about the patient 106 without an invitation from the patient is described below with respect to FIG. 6.

If the patient-selected healthcare providers are not registered with the PHIM system 104, the processing proceeds to step 504. To determine whether healthcare providers 102 can be associated with the patient 106 in the PHIM system 104, the processing proceeds to decision step 506. In step 506, it is determined whether the patient 102 is a member of the PHIM system 104. If the patient 106 is not registered with the PHIM system 104, the processing proceeds to step 508. In step 508, the system PHIM 104 instructs the patient to join the PHIM system 104 in order to allow the healthcare providers 102 to be invited for submission of medical information.

If the patient 106 joins the PHIM system 104, the processing proceeds to step 512. By joining the PHIM system 104, the patient registers with the system and provides his personal information as well as any medical information that he or she is aware of. Once the patient joins the PHIM system 104, the processing proceeds to step 520 (described below).

If the patient 106 does not join the PHIM system 104, as indicated in step 510, the processing proceeds to step 514. In step 514, the PHIM system 104 notifies the patient 106 that a generic request can be sent to the patient-selected healthcare providers 102 to ask them to register with PHIM system 104. Once patient-selected healthcare providers 102 register with the system, the providers can be invited to submit information about the patient to the PHIM system 104. This is indicated in step 518, which is described above.

If in step 506 it is decided that the patient 106 is a member of the PHIM system 104, then the processing proceeds to step 520. In step 520, the patient 106 submits contact information for his or her selected healthcare providers 102. These providers 102 will register (as will be indicated in step 522) with the PHIM system 104 and will be invited to submit information about the patient 106.

In step 522, the PHIM system 104 contacts patient-selected healthcare providers 106 and requests that they register with the PHIM system 104, as stated above. Then, the processing proceeds to step 524. In step 524, the PHIM system 104 notifies the patient 106 that the patient-selected healthcare providers 102 joined the PHIM system 104. The patient-selected healthcare providers 102 can now be invited to submit information about the patient 106 to the PHIM system 104. Then, the processing proceeds to step 518, which was described above.

FIG. 6 describes a process 600 for registration of a healthcare provider 102 with the PHIM system 104. Process 600 begins with step 602, where healthcare provider 102 registers with PHIM system 104. By registering with PHIM system 104 the healthcare provider 102 supplies information about itself. The information can include name, title, medical certifications, medical specialties, medical affiliations, tax ID numbers, and any other information. The information can be submitted electronically via email, by regular mail, via telephone, or in any other way. In an embodiment, the present invention provides a website on the World Wide Web, which the healthcare provider can access. Upon access, the healthcare provider 102 inputs the applicable information about itself and submits this information to the PHIM system 104. As can be understood by one having ordinary skill in the relevant art, other registration methods can be used to allow healthcare provider 102 to register with the PHIM system 104.

In step 604, the PHIM system 104 authenticates the registering healthcare provider 102. This step allows the PHIM system 104 to verify the identity of the registering healthcare provider 102. Any conventional authentication techniques can be used, such as verifying healthcare provider submitted information against existing databases containing information about healthcare providers. The processing proceeds to step 606, where it is determined whether the registering healthcare provider is authenticated.

If the healthcare provider 102 is not authenticated, then the processing proceeds to step 608. In step 608, the PHIM system requests additional information for authentication purposes. This request can be submitted via email, regular mail, instant internet communication (e.g., instant messenger), or any other means. The request is generated based on the information that the registering healthcare provider 102 has already entered. The PHIM system 104 determines whether any required information is missing and generates the request.

Assuming that the registering healthcare provider 102 submits the requested information, it is determined whether the additional information provided in step 608 is sufficient for authentication purposes. This is described in decision step 610.

If the information is sufficient to authenticate the registering healthcare provider 102 with the PHIM system 104, the processing proceeds to step 614 (described below). If the information is insufficient, then PHIM system 104 denies access to the registering healthcare provider 102. In an embodiment, the healthcare provider 102 can attempt to re-register with the PHIM system 104 at a later time. The provider will have to repeat the registration process again.

If the registering healthcare provider 102 is authenticated, as it is shown in step 614, then the processing proceeds to decision step 616. In step 616, the PHIM system 104 determines whether the authenticated healthcare provider 102 requested group administrator rights. The group administrator rights allow the healthcare provider to submit information from a group of healthcare providers that examined a particular patient or a family of patients. These rights also allow entire family of patients to submit medical information to the PHIM system 104 regarding the family members. These rights may also allow custodians of a patient to submit information as well. Also, the group administrator rights allow medical specialists to have access to specified information about the patient (e.g., a patient grants a right to change information about patient's children to a pediatrician). If the authenticated healthcare provider 102 requested such rights, then processing proceeds to step 618.

In step 618, the PHIM system 104 attests group administrator rights to the healthcare provider 102. If the attestation process is complete, then the processing proceeds to step 620. In step 620, the group administrator rights are granted to the registered and authenticated healthcare provider. If the attestation process cannot be completed, then the processing proceeds to step 622. In step 622, the PHIM system 104 denies group administrator rights to the healthcare provider 102. In an embodiment, if the provider 102 desires to obtain such rights, it may repeat the process and attempt to secure these rights. Some additional information may be required from the healthcare provider (e.g., permission from other healthcare providers 102 to the registered and authenticated healthcare provider 102 to interact with PHIM system 104 on their behalf with respect to a particular patient).

As stated above, the methods 500 and 600 (of FIGS. 5 and 6, respectively) assure a particular patient 106 that the registering healthcare provider 102 is a valid healthcare provider that has information about the patient. Further, the methods 500 and 600 also assure the patient 106 that the information will not be disclosed to any unauthorized third parties. In an embodiment, the methods 500 and 600 can be performed using a secure website interface that employs at least a 128 Bit connection. As can be understood by one having ordinary skill in the art, there are other ways of obtaining information from the patients and healthcare providers and performing these methods.

In an embodiment, the PHIM system 104 allows a patient 106 to grant permission to the healthcare provider 102 to change medical information about the patient 106 on as needed basis. This is different from blanket access permission, where the healthcare provider 102 has a constant permission to change patient's medical information.

In an alternate embodiment, a large healthcare provider group practice may wish to have its staff relieved of managing records and utilize the PHIM system 104. The healthcare provider 102 and/or the PHIM system can send communication to all patients 106 in practice regarding the system (and/or methods according to the present invention) and invite the patients to register and join the PHIM system 104. The registration and authentication processes (described in FIGS. 5 and 6) are similar.

In yet another alternate embodiment, the healthcare provider 102 can be a home care agency that manages multiple specialized home care programs (such as, hospice, high-risk pregnancy, IV infusion program, etc.). Using PHIM system 104, these healthcare providers 102 can manage information from family, physician and any facilities the patient periodically receives care/services from. As the case manager coordinating and orchestrating multiple care activities, these healthcare providers need to be a central place of communication of all patient's information. Each healthcare provider (including doctors, nurses, medical technicians, etc.) can have access to the PHIM system 104 (as designated by the patient 106) and manage documents and grant access rights (also as designated by the patient 106) to facilitate efficient and prompt health information management.

In yet another alternate embodiment, the PHIM system 104 can be implemented in a nursing facility that provides care for patients with multiple, often specialized nursing and medical needs. Often individuals who are responsible for the day-to-day medical care decisions for a patient (e.g., patient custodians, individual having a medical power of attorney granted to them, family members, etc.) are inaccessible. However, the nursing facility staff and case managers need immediate access to significant past medical history, procedures and studies results to devise a proper treatment plan for a patient 106. By having access to the PHIM system, case/unit managers manage significant health information and communicate with those who are responsible for making day-to-day medical care decisions. For example, a designated nurse, having access to the patient's PHIM system medical record, manages documents and grants access rights (also as designated by the patient) to facilitate efficient and prompt health information management.

The PHIM system 104 can also be implemented in the managed care environment. The managed care environment provides a plurality of health plans that can be tailored to the specific groups of individuals. The health plans are also dependent upon the organization's ability to successfully manage and support its network of healthcare providers. Because of the integral relationship between the health plan and the healthcare providers and the plan's responsibility to ensure the quality of care and services consumers receive, the PHIM system 104 reduces duplication of medical records, increases healthcare providers' efficiency and quality of care.

In the managed care environment, the PHIM acts as an intermediary between the managed care health plan, healthcare providers, and members creating patient accounts. The PHIM system is also responsible for uploading documents and maintaining accurate information as submitted by account members (i.e., patients and healthcare providers). In emergency situations, an immediate access and authorization is important to provide adequate medical care to a patient. As such, the PHIM system 104 can be authorized and accessed using various access means. These include Smartcards, cellular telephones, computers with wireless access, PDAs, blackberries, as well as regular telephones, facsimile machines, and other communication equipment. A detailed authentication process has been designed for a patient who may be unconscious but who carries an access card with an 800 number to be used to authenticate an emergency room provider (See, FIG. 6 for further description).

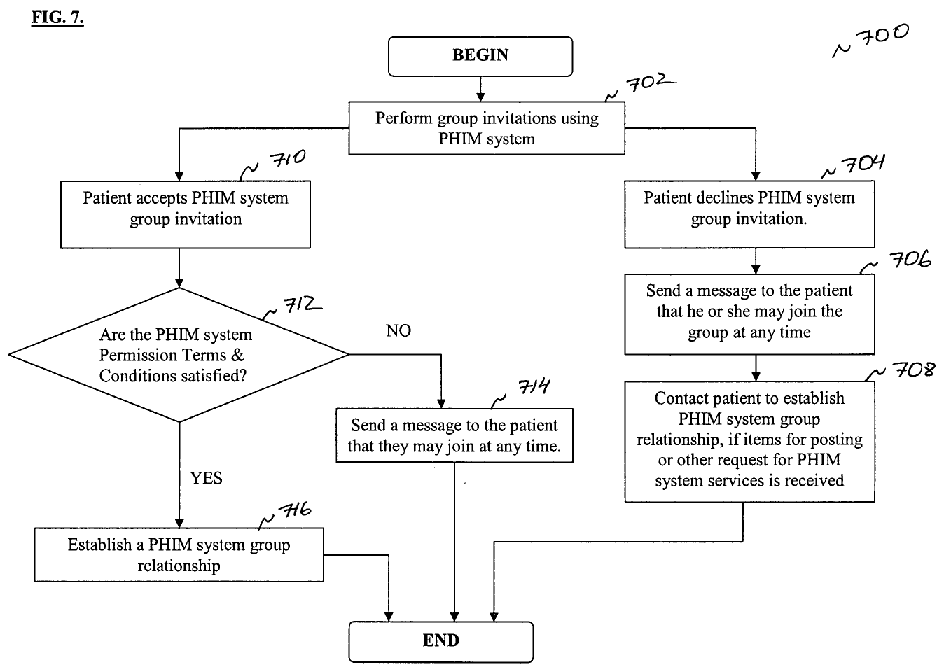

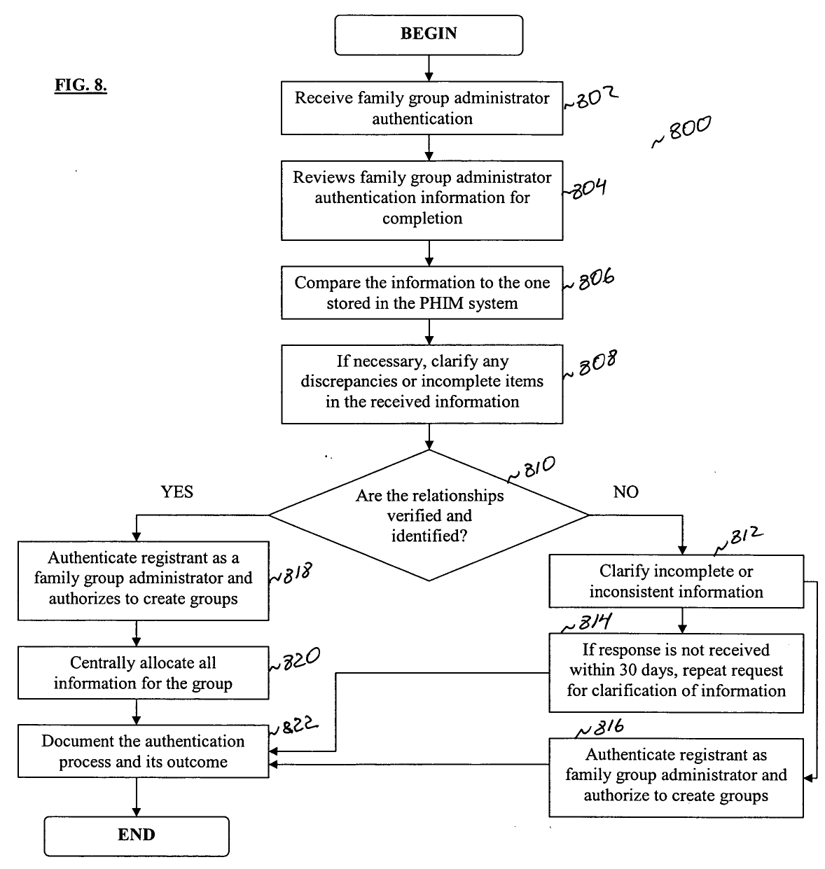

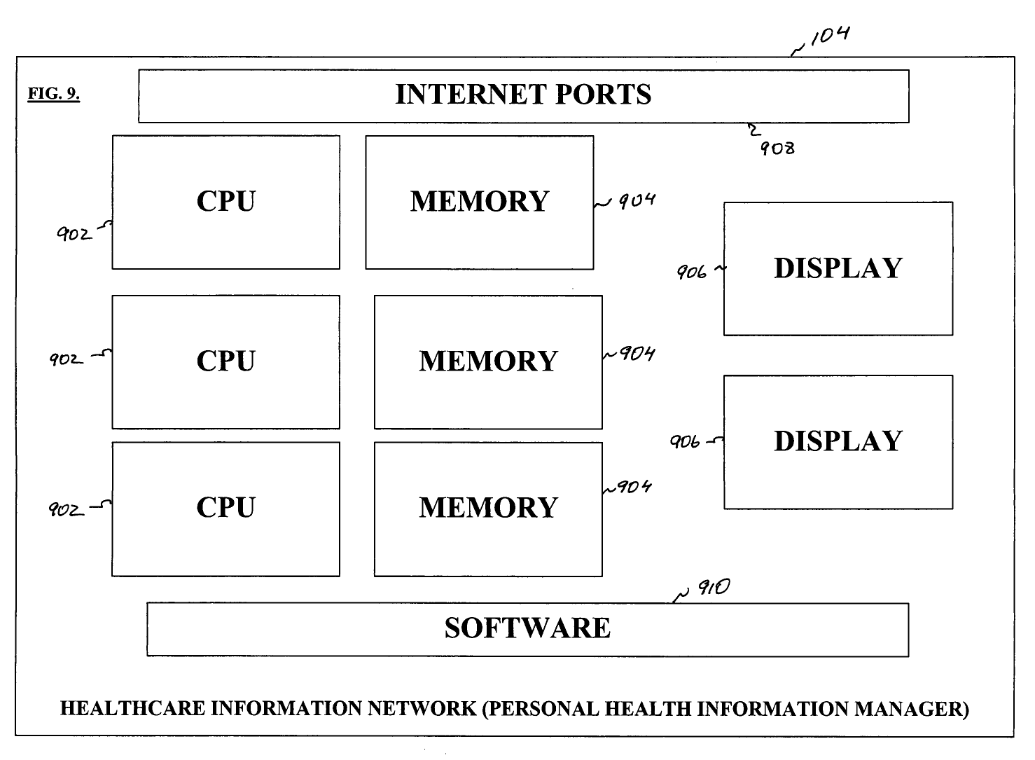

FIG. 7 illustrates method 700 for processing group method invitations discussed with respect method 600. Process 700 begins with step 702. In step 702, the PHIM system 104 sends out group invitations to the patients. Here, patients 106 can grant group administrator rights to various healthcare providers 102 for their family members or other patients 106. This allows various healthcare providers to change or otherwise submit information about patients to the PHIM system account. As can be understood by one having ordinary skill in the relevant art, the healthcare providers for the group can include physicians, specialists, hospitals, medical clinics, pharmacies, and other types of healthcare providers.

If patient 106 declines PHIM system 104 invitation, as shown in step 704, the processing proceeds to step 706. In step 706, the PHIM system 104 can send a message to the patient 106 stating that he or she may join the group at any time. However, if the patient 106 or its healthcare providers 102 submitted any information about the patient medical conditions or other type of information, the PHIM system 104 will contact the patient and prompt him or her to join the group relationship. This assures proper record-keeping procedures and accuracy of the patient's and its family's medical records.

If the patient 106 accepted the PHIM system 104 group invitation, as shown in step 710, the processing proceeds to step 712. In step 712, the PHIM system 104 determines if the access can be granted to the records. The system 104 determines if the patient satisfied all terms and conditions that are needed to grant access to the medical records. The terms and conditions may be set in accordance with Health Insurance Portability and Accountability Act of 1996 (“HIPAA”) requirements for privacy and confidentiality of patient's records.

If the conditions are satisfied, then the PHIM system 104 establishes a group relationship with the patient 106, as shown in step 716. If the conditions are not satisfied, then the PHIM system 106 sends a message to the patient 106 stating that they may join the group relationship at any time.

FIG. 8 illustrates an exemplary embodiment of a method 800 of processing and workflow of documents and information for a PHIM system 104 group administrator (as it is discussed with respect to FIGS. 6 and 7 above). Method 800 begins with step 802, where the PHIM system 104 receives family group administrator authentication information. This information can be transmitted via email, instant message, telephone call, facsimile, or any other means of communication. The information can include names, address, medical history information, and other information that personal to a patient's family member. The patient, who is acting as the family group administrator (“FGA”), sends the information to PHIM system 104.

In step 804, the PHIM system 104 reviews the information provided by the FGA for completion. Once the review is completed, the PHIM system 104 compares FGA information to the one currently stored in the PHIM system 104. Specifically, identification information along with medical history information is compared. The processing then proceeds to step 808.

In step 808, the PHIM system 104 clarifies any discrepancy between the submitted FGA information and the one that is currently stored in the system. Then, a determination is made as to whether all relationships defined by the FGA information (i.e., parent-child, custodian-patient, etc.) can be identified and verified, as shown in step 810. If not, then processing proceeds to step 812. In step 812, any missing information is gathered, identified, and verified by the PHIM system 104. This can be done via email, instant messaging, facsimile, mail, and other ways of communication.

If all FGA information is completed and verified, the processing proceeds to step 816, where FGA registrant is authenticated as a family group administrator. Further, authorization is given to the FGA to create any necessary family groups (i.e., husband-wife, parent-child, custodian-patient, etc.). The step 816's authentication is documented in step 822. The PHIM system 104 records the authority of the FGA in with the PHIM system 104 so that healthcare providers 102 are aware of the FGA.

However, if the missing information is not received within 30 days or any other pre-set period of time, the FGA is contacted in an attempt to provide missing information after expiration of the time period. This can be done via email, instant messaging, facsimile, telephone, mail, or any other means of communication. However, if response is again not received, then FGA rights are denied to the FGA registrant. The FGA registrant is notified of the denial. Then, processing proceeds to step 822 described above, where the denial is recorded with the PHIM system 104.

If the family relationships are identified and verified in step 810, then the FGA registrant is authenticated as the family group administrator and an authority is given to create groups, as shown in step 818. This step is similar to step 816, described above.

Then, the information relating to various members of the group is centrally allocated to the FGA account, as shown in step 820. This allows healthcare providers 102 to access all information about group members at once. The processing then proceeds to step 822, described above.

Example embodiments of the family group administrator rights can include situation of two parents with children (a traditional family unit), adult child and senior parent, custodian patient, and others. In the two parents with children situation, FGA relationships can be granted to multiple healthcare providers. One or both parents can be family group administrators. In the adult child and senior parent situation, the adult child can be the family group administrator. Senior parent accepts family group invitation when one is sent out by the adult child (as described in FIG. 8). As with the first situation, the FGA relationship rights can be granted to parent's multiple providers. As can be understood by one having ordinary skill in the relevant art, other relationship rights can be granted. Further, these rights can be granted on as needed basis, which depends on the medical need of the patient.

FIG. 2-4 illustrate an alternate embodiment of a method 200 for managing health record of a patient. Specifically, method 200 allows patients 106 and healthcare providers 102 to interact with each other through PHIM system 104 (shown in FIG. 1).

The method 200 begins with registering a patient 106 with a healthcare information network, as shown in step 202. In an embodiment, the healthcare information network is the PHIM system 104. The processing then proceeds to step 204.

In step 204, a healthcare account for the patient 106 is established with the PHIM system 104 (or the healthcare information network) (It should be noted that the PHIM system and the healthcare information network are used interchangeably for the purposes of this description). The healthcare account can include medical and personal information about the patient 106. The processing proceeds to step 206.

In step 206, the PHIM system 104 gathers personal and medical information about the patient 106. As stated above, the medical information relates to the health of the patient 106. The gathering step 206 further includes steps 208 and 210.

In step 208, the PHIM system 104, requests at least one healthcare provider 102 of the patient to register with the PHIM system 104.

In step 210, the PHIM system 104 receives information about the health of the patient from at least one entity associated with the patient 106. The entities include the at least one healthcare provider 102 of the patient 106, the patient 106, at least one custodian of the patient 106, if any, and any other entity related to the patient. Then the processing proceeds to step 212.

In step 212, the PHIM system 104 compiles a health record summary of the healthcare account of the patient 106. The health record summary is based on the personal and medical information received from the patient 106 and the at least one healthcare provider 102 of the patient 106. Further, the health record summary can be a shortened version of the individual's medical history and other vital information required for treatment of the patient 106. Examples include: allergies, medications, blood pressure information, and others. The processing then proceeds to step 214.

In step 214, the PHIM system 104 requests that additional healthcare providers 102 of the patient 106 register with the PHIM system 104 and supply information about the health of the patient. Based on the information received from the additional healthcare providers 102, the PHIM system 104 updates the health record summary.

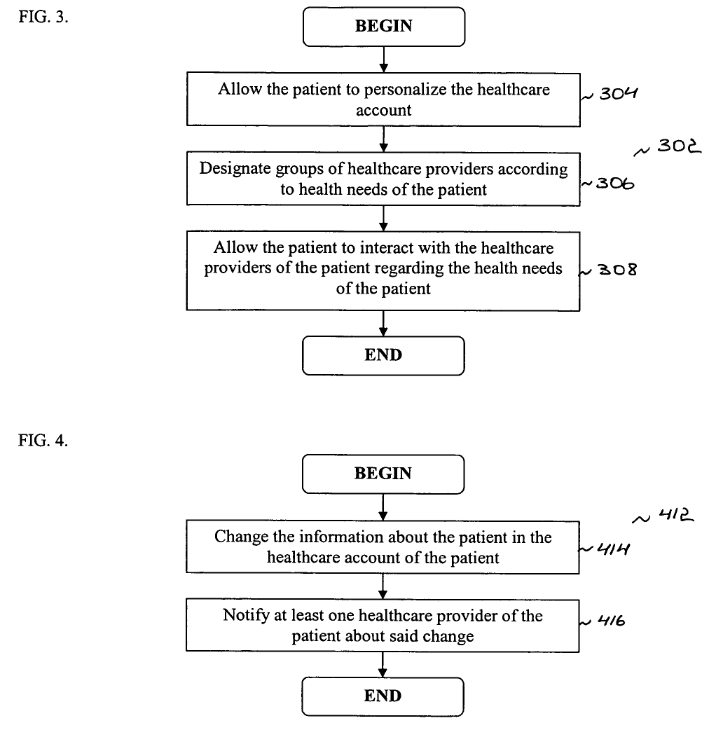

FIG. 3 illustrates a method 302, which is an alternate embodiment of the method 200. Method 302 includes steps performed in addition to the steps shown in FIG. 2. Method 302 allows a patient 106 to personalize his or her PHIM system 104 account, as shown in step 304. Further, the patient 106 can designate groups of healthcare providers 102 according to the needs of the patient 106 (e.g., pediatricians, ophthalmologists, etc.). The patient 106 is also allowed to interact with the healthcare providers 102 via the PHIM system 104. The patient 106 interacts with providers 102 regarding his or her health, proposed treatment plan, necessary medications, alternative treatments, and others.

FIG. 4 illustrates a method 412, which is an alternate embodiment of the method 200. Similar to method 302, method 412 includes steps performed in addition to the steps shown in FIG. 2. Method 412 begins with step 414. In step 414, the information contained in a patient's healthcare account is changed. As stated above, this can be done by the healthcare providers 102, the patient 106, or anyone associated with the patient that has sufficient authority to do so. In step 416, healthcare providers 102 are notified of the changes to the patient's healthcare account. Further, the patient 106, besides being able to update the healthcare account on the PHIM system 104, can update the information in the health record summary as well. Alternatively, the healthcare provider 102 can update the health record summary. The provider 102 would need appropriate authorization from the patient 106 to do so. This is described above with respect to FIGS. 5-8.

In an embodiment, patients 106, PHIM system 104, and healthcare providers 102 communicate with each other using a secure Internet connection (e.g., a 128 bit connection). Alternatively, communication can be performed using facsimile, telephone, mail, or any other means of communication.

As stated above, the healthcare provider 102 can be a physician of the patient, a hospital, a medical clinic, a medical specialist, a dental professional, or any other medical professional. The patient 106 can be a person or a family. The medical information can include medications taken by the patient, medical conditions of the patient, allergies of the patient, and treatment options tailored to the patient. The personal information includes first name of the patient, last name of the patient, date of birth of the patient, address of the patient, and emergency contact for the patient. Patient's health record summary or the entire account is accessible using a Smartcard, cellular telephone, PDA, computer, telephone, or any other means of communication.

Example embodiments of the methods and components of the present invention have been described herein. As noted elsewhere, these example embodiments have been described for illustrative purposes only, and are not limiting. Other embodiments are possible and are covered by the invention. Such embodiments will be apparent to persons skilled in the relevant art(s) based on the teachings contained herein. Thus, the breadth and scope of the present invention should not be limited by any of the above-described exemplary embodiments, but should be defined only in accordance with the following claims and their equivalents.

What is claimed:

1. A method for managing health records of a patient on a healthcare information network, comprising the steps of:
registering the patient with the healthcare information network;
establishing a healthcare account for the patient, wherein the healthcare account is configured to include medical and personal information about the patient;
gathering personal and medical information about the patient, wherein the medical information relates to the health of the patient;
wherein said gathering step further comprises:
requesting at least one healthcare provider of the patient to register with the healthcare information network; and
receiving information about the health of the patient from at least one entity selected from a group consisting of at least one healthcare provider of the patient, the patient, at least one custodian of the patient, and any entity relating to the patient;
compiling a health record summary of the healthcare account of the patient, wherein the health record summary is based on the personal and medical information received from the patient and the healthcare provider of the patient;
requesting additional healthcare providers for the patient to register with the healthcare information network and supply information about the health of the patient; and
updating the health record summary.

2. The method of claim 1, further comprising:
allowing the patient to personalize the healthcare account;
wherein said personalization includes:
designating groups of healthcare providers according to health needs of the patient; and
allowing the patient to interact with the healthcare providers of the patient regarding the health needs of the patient.

3. The method of claim 1, wherein said updating step further comprises:
changing the information about the patient in the healthcare account of the patient; and
notifying at least one healthcare provider of the patient about said change.

4. The method of claim 1, wherein said healthcare provider is selected from a group consisting of: a physician of the patient, a hospital, a medical clinic, a medical specialist, and a dental professional.

5. The method of claim 1, wherein said patient is selected from a group consisting of: a person and a family.

6. The method of claim 1, wherein said updating step further comprises:
allowing the patient to update the health record summary of the patient.

7. The method of claim 1, wherein said updating step further comprises:
allowing the at least one healthcare provider for the patient to update the health record summary of the patient.

8. The method of claim 1, wherein said medical information is selected from a group consisting of: medications taken by the patient, medical conditions of the patient, allergies of the patient, and treatment options tailored to the patient.

9. The method of claim 1, wherein said personal information is selected from a group consisting of: first name of the patient, last name of the patient, date of birth of the patient, address of the patient, and emergency contact for the patient.

10. The method of claim 1, wherein said gathering step further comprises:
gathering the personal and medical information using secure communications.

11. The method of claim 1, further comprising:
accessing the health record summary of the patient using at least one device selected from a group consisting of: a Smartcard, a cellular telephone, a PDA, a computer, and a telephone.

12. A system for managing health records of a patient on a healthcare information network, comprising:
a means for registering the patient with the healthcare information network;
a means for establishing a healthcare account for the patient, wherein the healthcare account is configured to include medical and personal information about the patient;
a means for gathering personal and medical information about the patient, wherein the medical information relates to the health of the patient;
wherein said gathering means further comprises:
a means for requesting at least one healthcare provider of the patient to register with the healthcare information network; and
a means for receiving information about the health of the patient from at least one entity selected from a group consisting of at least one healthcare provider of the patient, the patient, at least one custodian of the patient, and any entity relating to the patient;
a means for compiling a health record summary of the healthcare account of the patient, wherein the health record summary is based on the personal and medical information received from the patient and the healthcare provider of the patient;
a means for requesting additional healthcare providers for the patient to register with the healthcare information network and supply information about the health of the patient; and
a means for updating the health record summary.

13. The system of claim 12, further comprising:
a means for allowing the patient to personalize the healthcare account;
wherein said personalization includes:
a means for designating groups of healthcare providers according to health needs of the patient; and
a means for allowing the patient to interact with the healthcare providers of the patient regarding the health needs of the patient.

14. The system of claim 12, wherein said updating means further comprises:
a means for changing the information about the patient in the healthcare account of the patient; and
a means for notifying at least one healthcare provider of the patient about said change.

15. The system of claim 12, wherein said healthcare provider is selected from a group consisting of: a physician of the patient, a hospital, a medical clinic, a medical specialist, and a dental professional.

16. The system of claim 12, wherein said patient is selected from a group consisting of: a person and a family.

17. The system of claim 12, wherein said updating means further comprises:
a means for allowing the patient to update the health record summary of the patient.

18. The system of claim 12, wherein said updating means further comprises:
a means for allowing the at least one healthcare provider for the patient to update the health record summary of the patient.

19. The system of claim 12, wherein said medical information is selected from a group consisting of: medications taken by the patient, medical conditions of the patient, allergies of the patient, and treatment options tailored to the patient.

20. The system of claim 12, wherein said personal information is selected from a group consisting of: first name of the patient, last name of the patient, date of birth of the patient, address of the patient, and emergency contact for the patient.

21. A method for managing patient healthcare information on a healthcare information network, comprising the steps of:
creating a patient account on the healthcare information network, wherein the patient account includes personal and medical information about the patient;
inviting at least one healthcare provider to register with the healthcare information network and become affiliated with the patient account;
receiving information from the at least one healthcare provider about the patient;
allocating the at least one healthcare provider to a group of healthcare providers, wherein the group is composed of a plurality of member healthcare providers and is associated with the patient account;
allowing the members of the group to share information about the patient; and
generating a health record summary for the patient based on the sharing.
